(19) United States
(12) Patent Application Publication
(10) Pub. No.: US 2012/0200431 A1
(43) Pub. Date: Aug. 9, 2012

(54) Traffic monitoring system and method

(76) Inventor: Rick Andrew Ross, McKinney, TX (US)

(21) Appl. No.: 13/374,962

(22) Filed: Jan. 25, 2012

Related U.S. Application Data
(60) Provisional application No. 61/462,479, filed on Feb. 3, 2011.

(51) Int. Cl. G08G 1/01; G08G 1/054; G08G 1/04

(52) U.S. Cl. 340/936; 340/942; 340/937

(57) ABSTRACT

Vehicle and traffic data collection and processing systems and methods are disclosed. Data sampling areas may be designed and equipped with adjustable pyroelectric infrared sensors, a camera, and a network interface card that may be used to monitor and transmit traffic data. The traffic data may be used to provide instantaneous reporting of traffic speeds and even speed violations to municipal traffic control systems but should improve city wide traffic condition communications for overall reduced drive times, improved fuel usage and reduced carbon emissions from vehicular traffic.

The present application claims priority to provisional patent application Ser. No. 61/462,479, filed Feb. 3, 2011 and entitled “Traffic monitoring system and method.” The entire disclosure of which is hereby incorporated by reference.

### FIELD OF THE INVENTION

The present invention relates to traffic monitoring systems and methods.

### DESCRIPTION OF THE RELATED ART

It is common for police officers to monitor vehicle speeds with radar guns. The use of radar guns can be limited by the number of police officers available to use the radar guns. Some automated traffic monitoring systems have been implemented. For example, some traffic monitoring systems use data collected at tollbooths. Such systems are either stationary or otherwise have locations that are readily apparent to drivers.

Therefore, there is a need in the art for discrete and automated traffic monitoring systems.

### SUMMARY OF EMBODIMENTS OF THE INVENTION

Aspects of the present invention overcome problems and limitations of the prior art by providing a data sampling and communications network interface card that are configured to collect real time vehicle or traffic data and transmit simultaneously to a receiving head end network application. A data sampling and communications network interface card (NIC) th at may be used to monitor and transmit traffic data ma y be equipped with harsh environment photo electric sensors. The traffic data may be used to provide instantaneous reporting of traffic speeds and even speed violations to municipal traffic control systems. The transmission of traffic data may be through licensed or unlicensed frequency band mesh network technology and existing telecom carrier wide area network data transport systems and may be sent back to monitoring facilities, such as a municipal traffic control center to the receiving dispatch officer and emergency response units running the receiving application and streaming the live video.

In positioning the data sampling and communications network interface card within a ‘smart reflector’ on either serial row type lane dividing road markings or mounted on the vertical guardrails that frame multiple lanes to form a rectangular micromesh over a short stretch of roadway, a simple velocity algorithm (v=d/t) can be utilized to capture the change in distance with respect to time for a given passing motorist. The captured motorist velocity data can then be transmitted through the radio on the NIC to a repeater operating at the same frequency then further transported to a Smart Municipal Traffic Monitoring application through telecommunications data transport wide area networks instantaneously and displayed on traffic control response systems for action response decision making or ongoing traffic monitoring over a broader or citywide sampling area.

In certain embodiments, the present invention can be partially or wholly implemented on one or more tangible computer-readable media, for example, by storing computer-executable instructions or modules, or by utilizing computer-readable data structures.

Of course, the methods and systems of the above-referenced embodiments may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIGS. 1a-1c illustrate a data sampling and communications network interface card if used as a smart reflector system architecture in accordance with an embodiment of the invention;

FIG. 2 illustrates a data sampling and communications network interface card component, in accordance with an embodiment of the invention;

FIG. 3 illustrates a traffic monitoring application, in accordance with an embodiment of the invention;

FIG. 4 illustrates a smart reflector system operation involving average traffic density route monitoring, in accordance with an embodiment of the invention; and

FIG. 5 illustrates a smart reflector system operation, in accordance with another embodiment of the invention.

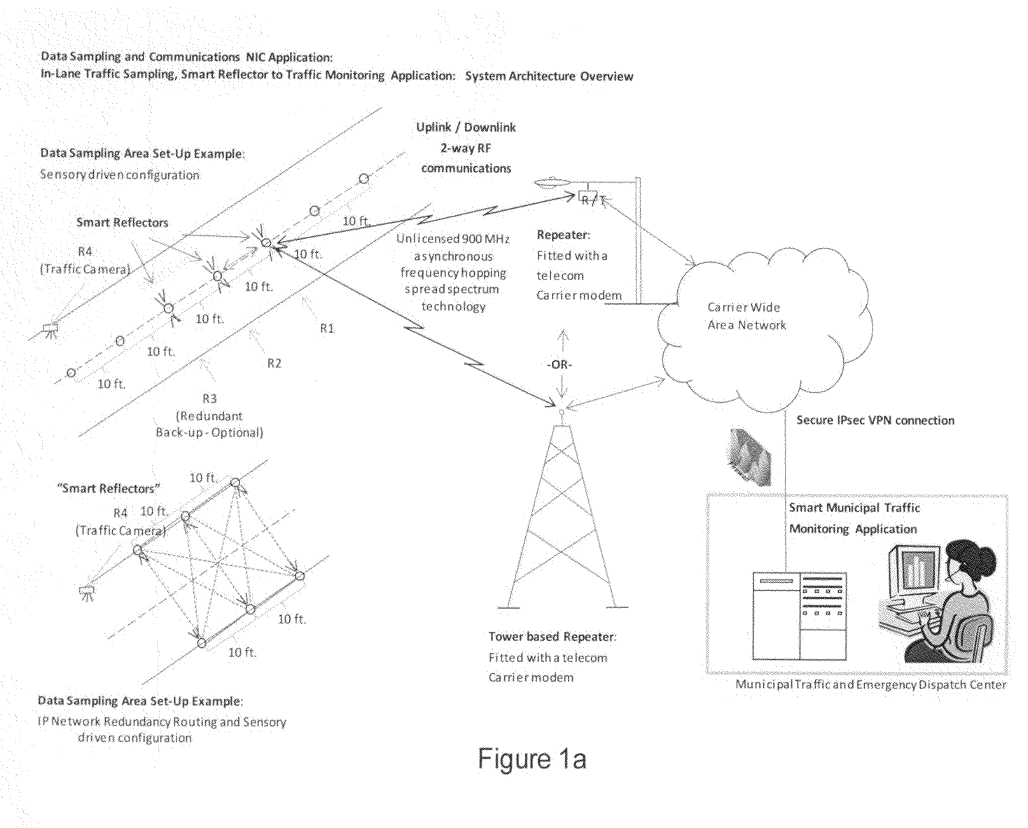

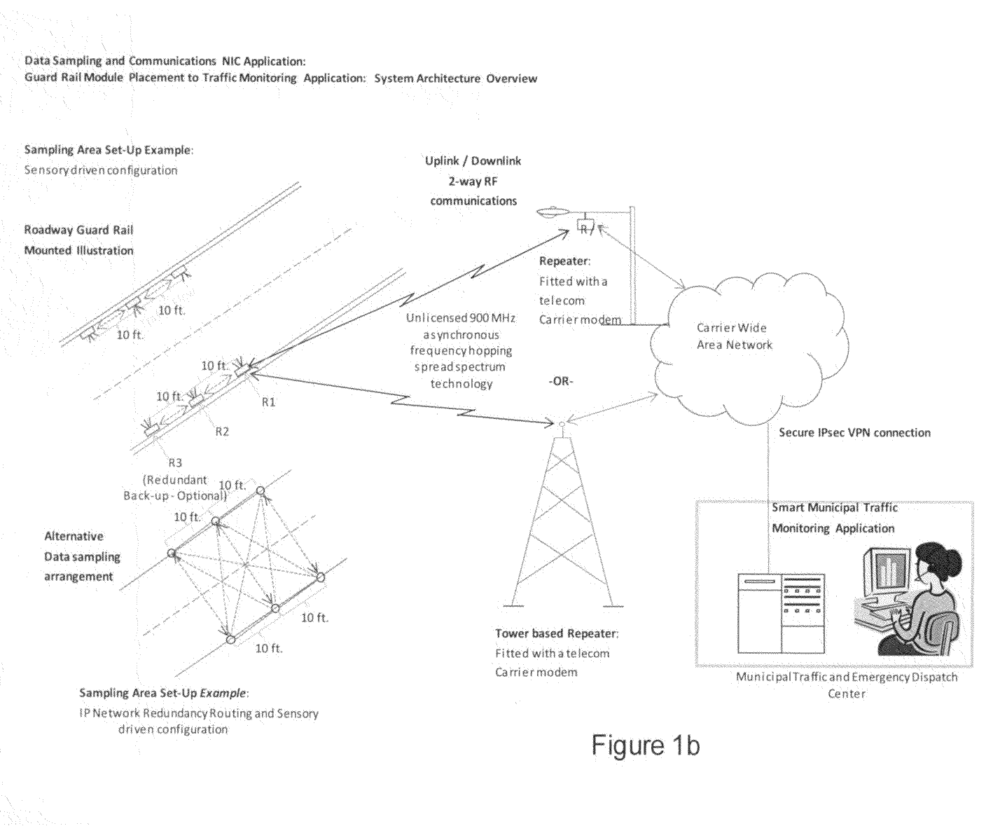

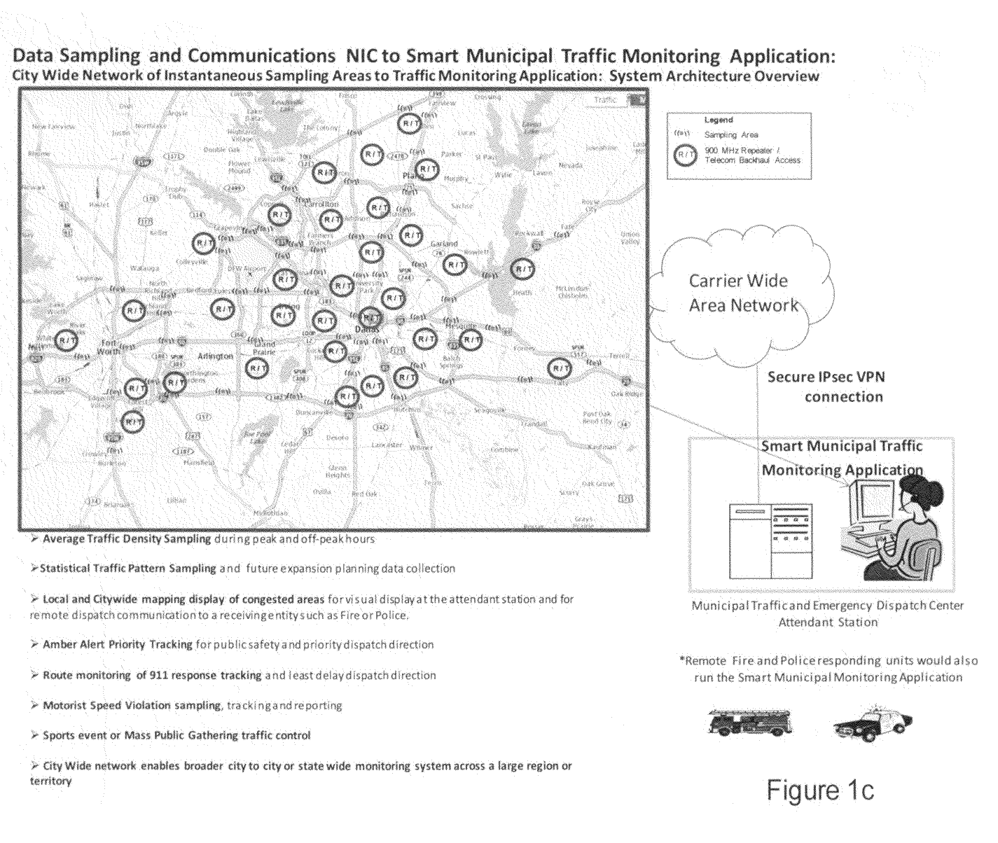

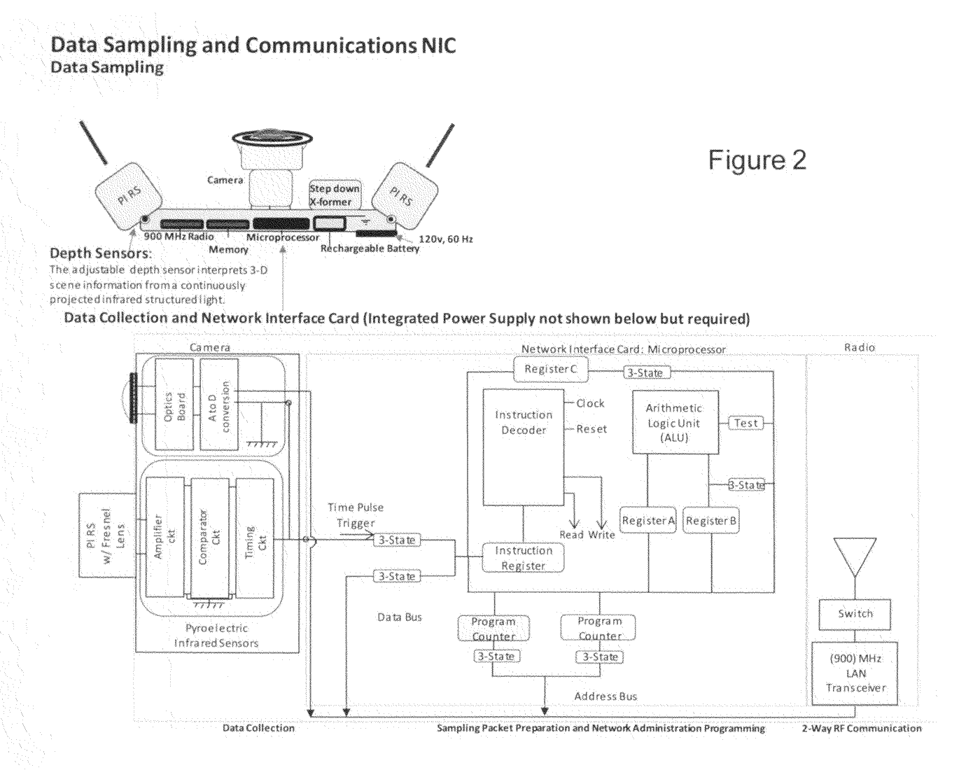

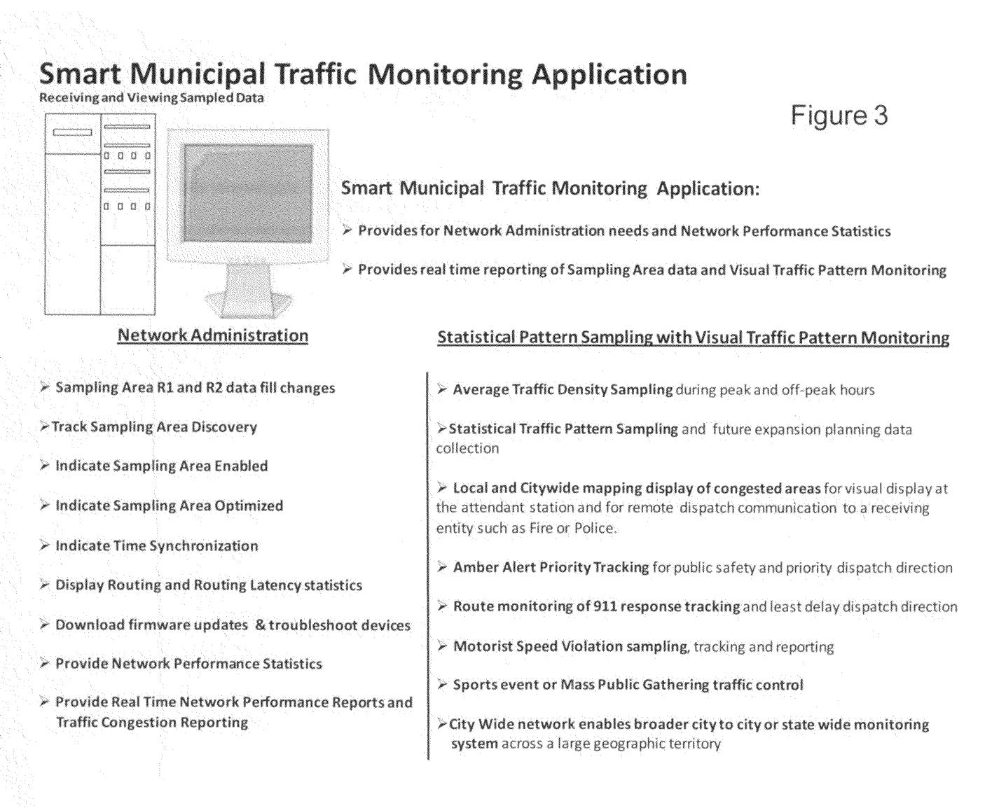

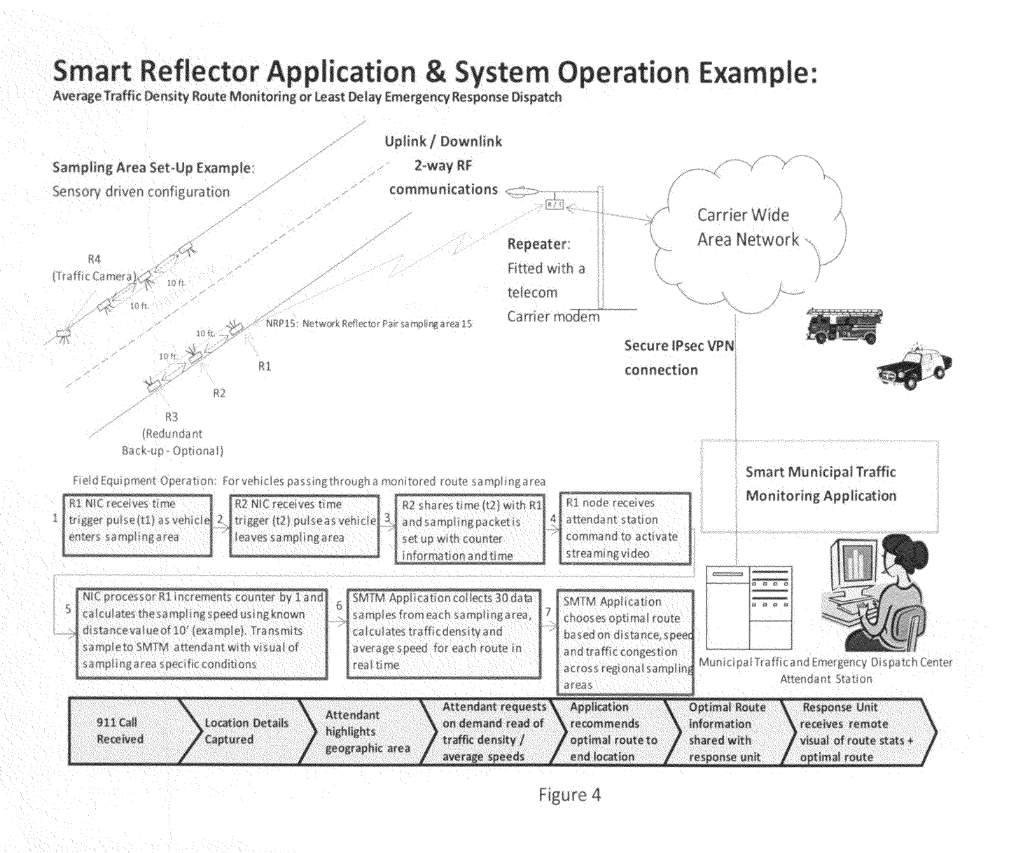

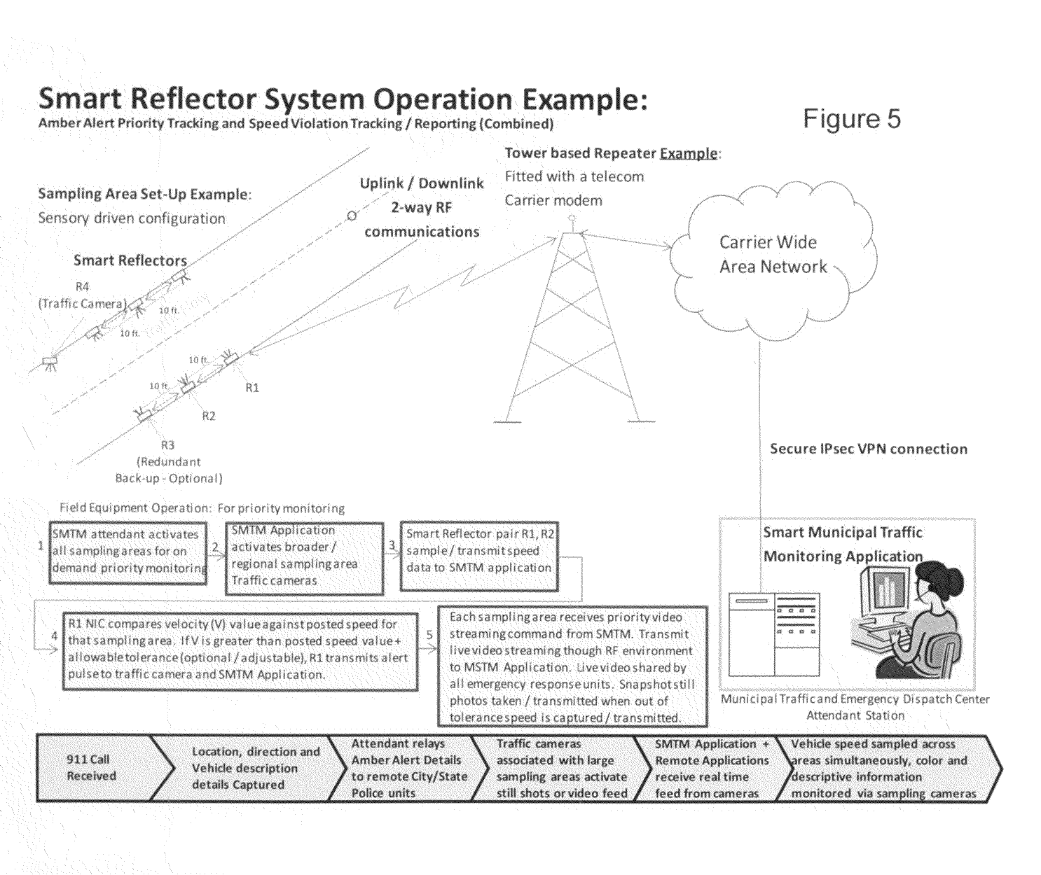

### DETAILED DESCRIPTION OF EMBODIMENTS OF THE INVENTION

In various embodiment of the invention common roadway lane reflectors can be exchanged with smart reflectors equipped with pyroelectric infrared sensors on a network interface card (NIC), to sample traffic conditions and provide localized mesh network communications instantaneously to a software application adapted for city municipal display, dispatch or traffic alert display and reporting. As used herein a “smart reflector” is a roadway reflector that includes electronic components configured to monitor traffic and transmit corresponding data. By defining either a single roadway data sampling area or a connected network of local data sampling areas logically connected to define traffic patterns, real time traffic data can be measured and transmitted. Data may be transmitted instantaneously, such as through a tower based or local repeaters equipped with modem access to telecom carrier backhaul transport. The data may ultimately be received at a software application designed to perform functions such receiving the data, displaying traffic conditions in a geographical area and providing dispatch direction or redirection.

### Smart Reflector Component and Network Application Description (SR)

The smart reflector itself may include a hard protective outer shell to protect the sensitive electronic components contained within from the weight of vehicles potentially running over the top of the reflector in normal traffic conditions. The shape of the reflector itself can be rounded in common half-sphere form to redistribute a downward force weight evenly around the reflector base. In one embodiment a combination of two reflectors operating serially are paired and capture vehicular speed (velocity=(d/(t1+t2)) over a predetermined distance spacing of the two reflectors (R1, R2) in a given sampling area. A minimum of two sets of paired smart reflectors over a span of roadway may be used to produce broader sampling area measurements. A variation of the same data sampling and communications network interface card fitted with a camera would be mounted on a vertical structure such as a guardrail for streaming video and still photos of sampling area traffic.

Pyroelectric infrared sensors may be used to detect the existence and the absence of an object by sensing the presence of an object from the photo emitting device, and the absence of an object from the same infrared receiving device which form a single sensor. By positioning two such paired adjustable sensors 180 degrees apart or ‘back to back’ and pointing in opposite directions upward at ˜approximately a 45 degree angle from the roadway pavement, the sensors can provide the time trigger pulse of a passing motorist in two adjacent lanes to the microprocessor on the network interface card (NIC) also contained within the smart reflector. As a vehicle passes by the infrared type photo sensor, the object is struck by the infrared light which is reflected and received detecting the presence or absence of the passing object. A first smart reflector (R1) in a serial network pair triggers the time pulse (t1) of motorist entry into the sampling area and a paired second smart reflector (R2) triggers the time pulse (t2) of the motorist leaving the sampling area. Separating the R1 and R2 by a distance, such as 10 feet, provides the value of distance (d).

A network interface card (NIC) within the smart reflector receives the time trigger pulse from the infrared sensor and applies the captured time data to a velocity algorithm for the serial pair of reflectors taking the sample over a known separated distance. This distance can vary but the captured value of ‘d’ is required to program and calibrate the sampling area.

Velocity=(fixed distance(d))/(Change in time(t2−t1) (equation 1)

As a vehicle enters into a defined sampling area, the front of the vehicle is sensed by the pyroelectric infrared sensor and a time trigger pulse (t1) for smart reflector number one (RI) is captured and stored by the NIC in R1.

As the vehicle leaves the sampling area, reverse logic is used in the infrared sensor (R2) to sense the first detection of the object and instead trigger a time pulse based the absence of the object as it leaves the sampling area and then capture and share the value of time (t2) with it's mated pair R1 via radio interface and programmed IP routing.

Example Calculations performed by the processor on the NIC

### Object Velocity

(10 ft/0.8 s)×(1 Mile/5,280 ft)×(3,600 s/1 hr)=8.52 Mile/hr (equation 2)

Or

(3 Meters/0.8 s)×(1 km/1000 Meters)×(3,600 s/1 hr)=13.50 km/hr (equation 3)

At the receipt of the t2 value by the NIC in R1, a counter in R1 is then augmented by one and a date and time stamped sample packet data filled. The microprocessor associated with the NIC in R1, may then apply the simple velocity algorithm and then label the sample according to the network reflector pair (NRP #), the counter value (C #), and captured velocity value (V #) to data fill the sample packet for transport back to the receiving application. The transport may be instantaneous. (Data Sample Example: ‘Network Reflector Pair sampling area 15, sampled the 10th car at 55 miles per hour’ could be labeled: (NRP15, C10, V55)).

If the sampled speed is greater than the posted speed+allowable Mile/Hr tolerance, R1 may be programmed to trigger either a camera single frame snapshot or video of the passing motorist or license plate to transmit to the receiving application and local authorities.

Smart reflector number one (R1) in this paired example may date and time stamp this sample in smart reflector R1 NIC's memory and transmit this packet information sample back to the receiving application via radio interface on the NIC itself through a tower based repeater or a common local repeater fitted with a telecom carrier modem for data transport backhaul access. Security of the data sample being transmitted can be achieved using an IPsec transport tunneling protocol back to the receiving smart municipal traffic monitoring application over the carrier wide area network (WAN). Broader application of a network of sampling areas can determine average speed of traffic flow on a given roadway of interest.

### Average Speed

Where ‘NRP’ is defined as network reflector pair, ‘C’ is defined as the vehicle count through a sampling area and the measured velocity (V) for that sampled count.

((NRP1,C1,V55)+(NRP1,C2,V52)+(NRP1,C3,V56)+. . . (NRP1,C30,V54))/(30)=Ave. Speed through NRP1 (for a defined 15-30 minute interval of time as an example) (equation 4)

Power supply requirements to the smart reflector harsh environment reflector type photo sensor and network interface card can be provided by an integrated power supply on the network interface card and a small replaceable battery.

The network interface card (NIC) firmware may provide data encryption and security, time synchronization, network discovery transmit and receive messaging to enable the sampling area and packet routing to adjacent NICs defined in a sampling area or a network of sampling areas.

### Smart Municipal Traffic Monitoring Application Description (SMTM)

In various embodiments this software application is intended to be strategically located at a municipal facility used for receiving emergency 911 requests and radio dispatch to emergency response systems associated with local and state police, fire departments as well as ambulance service at a minimum.

Network Administration tasks from the host smart municipal traffic monitoring (SMTM) application may include first setting up and then remotely enable a sampling area or a network of sampling areas through uplink/downlink RF communications to smart reflector devices and defined sampling area pairs or mesh configuration of local network pairs. The SMTM application may track the discovery of the devices in the RF environment at smart reflector installation and power up, defining and confirming a sampling area mated pair or creative sampling smart reflector configuration.

The SMTM application may support initial testing, tuning and optimization and final optimization reporting of each sampling area against a secondary velocity measurement reference such a police radar gun. The individual local sampling areas and/or the entire city wide visual of all sampling areas included in a city wide network application of the smart reflector paired sampling areas are displayed with commonly available mapping technology and software such as ‘Google Maps’ (for example).

The SMTM application may ensure ongoing time synchronization between individual devices, the SMTM application and any applications at the municipal facility also integrated together for data analysis, visual mapping display and municipal response and reporting purposes. The SMTM application may be configured to display the routing of individual sampling areas and sampling area configurations to adjacent network pairs or repeaters. The SMTM application may also be configured to provide daily network performance statistics, sampling area outage reporting for either individual sampling area elements or network repair, low battery power, replace maintenance as well as regional traffic statistics reporting and sampling on demand.

### Smart Reflector Sampling Area Network Design, System Operation in Situational Application

Sampling area network design may be flexible in that state and regulatory use of reflectors may influence actual smart reflector placement on the roadway, the physical distance between smart reflectors and potential creative configurations of sampling area pairs over a stretch of roadway for broader traffic sampling measurement.

Flexibility in defining localized sampling area configurations whether single lane measurement or multi-lane measurement and distance between each smart reflector and paired smart reflector sampling area and routing configuration may be defined and also redefined in the firmware for the network interface card and smart municipal traffic monitoring (SMTM) application. Transport equipment selection of repeater type (tower based point to multi-point) or local repeater (point to multi-point) equipped with telecom carrier modem for wide area network backhaul to the smart municipal traffic monitoring (SMTM) application may be at the same frequency and reachable such that the measured RF decibel value produces a reliable RF connection (example −70 dB) from the sampling area to the local or tower based repeater.

Based on the data collected from a network of sampling areas, smart reflector network system operation as applied to common situations effecting traffic flow may include: Average Traffic Density Sampling during peak and off-peak hours; Local and Citywide mapping display of congested areas for visual display at the attendant station and for remote dispatch communication to a receiving entity such as fire or police; Amber Alert Priority Tracking for public safety and priority dispatch direction (Note: may utilize a traffic camera with either single frame capture or video linkage to local network sampling devices); Route monitoring of 911 response tracking and least delay dispatch direction; Motorist Speed Violation sampling, tracking and reporting (Note: may utilize a traffic camera with either single frame capture or video linkage to local network sampling devices); and Sports event or Mass Public Gathering traffic control.

Those skilled in the art will appreciate that the invention is not limited to systems that include reflective components. Alternative embodiments of the invention may utilize other objects commonly found along roadways. For example, components that look like rocks or guard rail components may perform the functions of the smart reflectors described above. A hard protective outer shell may be used with embodiments that are likely to result in vehicles passing over the components.

In various embodiments computer-executable instructions are executed by computer processors. The computer-executable instruction may be software applications or firmware. Computer-executable instructions may be stored on tangible computer-readable media such as a magnetic memory, optical disc, DVD or hard disc drive.

While the invention has been described with respect to specific examples including presently preferred modes of carrying out the invention, those skilled in the art will appreciate that there are numerous variations and permutations of the above described systems and techniques that fall within the spirit and scope of the claims.

I claim:

1. An apparatus comprising:
at least one pyroelectric infrared sensor;
a network interface card including a tangible computer-readable memory that contains computer-executable instructions that when executed by a processor cause the network interface card to perform the steps comprising:
(a) controlling to the at least one pyroelectric infrared sensor to obtain vehicle movement data; and
(b) transmitting the obtained data.

2. The apparatus of claim 1, wherein the network interface card further includes a transmitter.

3. The apparatus of claim 1, wherein the computer-executable instructions, when executed by the processor, further cause the network interface card and the at least one pyroelectric infrared sensor to capture photographs.

4. The apparatus of claim 3, wherein (b) comprises transmitting at least one of the captured photographs.

5. The apparatus of claim 1, wherein the computer-executable instructions, when executed by the processor, further cause the network interface card and the at least one pyroelectric infrared sensor to capture video.

6. The apparatus of claim 5, wherein (b) comprises transmitting a video.

7. The apparatus of claim 1, further comprising a hard protective outer shell configured to protect the pyroelectric infrared sensor and the network interface card.

8. The apparatus of claim 7, further comprising reflective component located under a transparent section of the hard protective cover.

9. The apparatus of claim 1, wherein the network interface card further including a receiver configured to receive data.

10. The apparatus of claim 1, wherein the network interface card further including a receiver configured to receive data from multiple other network interface cards.

11. The apparatus of claim 1, wherein (b) comprises transmitting the obtained data to another network interface card.

12. The apparatus of claim 1, wherein (b) comprises transmitting the obtained data to a monitoring facility.

13. The apparatus of claim 1, wherein the vehicle movement data comprises at least one vehicle speed.

14. The apparatus of claim 1, wherein the vehicle movement data comprises a traffic condition.

15. The apparatus of claim 1, wherein the at least one pyroelectric infrared sensor is adjustable.

16. The apparatus of claim 15, wherein the computer-executable instructions, when executed by the processor, further cause the network interface card to:
(i) receive adjustment data; and
(ii) utilize the adjustment data to adjust at least one parameter of the at least one pyroelectric infrared sensor.

17. The apparatus of claim 16, wherein the at least one parameter comprises a sensitivity level.

18. A method of monitoring vehicle movement data comprising:
(a) placing data collection units that resemble roadway lane reflectors along a roadway;
(b) receiving data from the data collection units; and
(c) processing the data received in (b) to determine vehicle movement data.

19. The method of claim 18, wherein the vehicle movement data comprises at least a speed of one vehicle.

20. A tangible computer-readable memory that contains computer-executable instructions that when executed by a processor cause an apparatus to perform the steps comprising:
receiving sensor data from at least one pyroelectric infrared sensor;
processing the sensor data to generate vehicle movement data; and
transmitting the vehicle movement data.
